(19) United States
(12) Patent Application Publication
(10) Pub. No.: US 2005/0228769 A1
(43) Pub. Date: Oct. 13, 2005

(54) Method and programs for coping with operating system failures

(76) Inventors: Satoshi Oshima, Tachikawa (JP); Shinji Kimura, Sagamihara (JP); Yoshinori Wakai, Hadano (JP); Masayoshi Takasugi, Yokohama (JP)

Correspondence Address: MCDERMOTT WILL & EMERY LLP, 600 13TH STREET, N.W., WASHINGTON, DC, 20005-3096, US

(21) Appl. No.: 11/003,430

(22) Filed: Dec. 6, 2004

(30) Foreign Application Priority Data
Apr. 12, 2004 (JP) 2004-116367

(51) Int. Cl. G06F 17/30

(52) U.S. Cl. 707/1

(57) ABSTRACT

In provision against an unrecoverable failure in a first OS, a second OS for undertaking failure processing is loaded onto a memory beforehand. On detecting a failure in the first OS, a gate driver saves the first OS, moves the second OS to its executable area within the memory, and starts up the second OS. After this, control is transferred to a failure-processing application program placed under the control of the second OS.

### CLAIM OF PRIORITY

The present application claims priority from the Japanese patent application JP2004-116367 filed on Apr. 12, 2004, the content of which is hereby incorporated by reference into this application.

### BACKGROUND OF THE INVENTION

The present invention relates to a technology for coping with operating system failures.

There is an operating system as the software that forms the core of a computer system. Operating systems (OSs) are characterized by the fact that, as disclosed in the Japanese-language version (translated by N. Hikichi and E. Hikichi) of the original writing “Modern Operating Systems” (author: Andrew S. Tanenbaum), they make it possible to abstract hardware and, without depending on any specific hardware, develop application programs, by providing an extension machine. Also, operating systems have allowed not only the abstraction of hardware, but also reduction in application program development costs and the improvement of reliability, by providing the functions that have traditionally needed to be executed on the application program side, such as: providing a communication function by installing a standard communication procedure using communication devices; standardizing the file-system-based methods of arranging the information to be stored into storage devices; and so on.

In addition, modern operating systems make it possible to build thereinto the device drivers that have been separated for each I/O device, as control programs that can be statically or dynamically added/deleted. This structural feature has, in turn, made it possible to configure a computer by combining necessary I/O devices without incorporating all I/O device control routines that the operating system is to process, and hence to construct a computer system by building device drivers associated with each device into the operating system. Furthermore, a little more advanced operating systems have made it possible to reduce development costs for device drivers and improve the reliability thereof, by providing the facilities used in common for various device drivers.

System failures caused by software bugs, hardware failures, or other factors, occur in computer systems. Above all, in case of an unrecoverable failure in the operating system forming the core of a computer system, conventional response to the failure has been to acquire an on-failure memory state called “memory dump”, as failure information, and analyze the failure in accordance with the information. An architecture for providing a failure-processing facility to a device driver and acquiring failure information using various devices has also been put into practical use.

Debugging that applies a virtual machine (VM) is known as a scheme for coping with operating system failures. In this scheme, one of the guest operating systems placed under the control of the VM debugs the other guest operating system causing the failure.

### SUMMARY OF THE INVENTION

Conventional methods have been coped with an unrecoverable failure in an operating system by providing, on the assumption that specific hardware is present, a facility for coping with the failure after it has occurred, or by providing a failure-processing facility to the device drivers. Provision of a failure-processing facility depending on a specific device, however, poses a problem in that if a hardware failure occurs in that device itself, the failure cannot be processed. Also, providing a failure-processing facility to a device driver causes a problem in that since the operating system is placed in the unrecoverable failure state, the operating system must provide a failure-processing facility without using the device driver facilities supplied from the operating system in order to achieve a high-reliability operating system.

Additionally, since the operating system is in the unrecoverable failure state, it is difficult to implement a failure-processing facility based on an application program operating on the operating system, a failure-processing facility that assumes the linking or collaboration between device drivers that must be conducted through the operating system, or a failure-processing facility based on the linking or collaboration between an application program and device drivers. Furthermore, there has been a problem in that even if any such failure-processing facility can be provided, the facility naturally decreases in reliability since the operating system is in the unrecoverable failure state.

Besides, during failure processing that applies a VM, since a VM control program intervenes for communication between the failure-causing guest operating system and a guest operating system which processes the failure, there are the problems in that a CPU overhead occurs and that VM usage increases a memory overhead.

In provision against an unrecoverable failure in a first operating system (first OS), a computer of the present invention loads a second operating system (second OS) as failure-processing software onto a memory beforehand. On detecting a failure in the first OS, the computer activates the second OS to process the failure.

According to the present invention, after the second OS has been started up, failure processing can be progressed just by accessing a first OS area and second OS area present on the memory, and using the available devices. This makes it possible to achieve the low-cost and high-reliability processing of OS failures.

### BRIEF DESCRIPTION OF THE DRAWINGS

FIG. 1 is a diagram showing a hardware configuration of a computer according to an embodiment;

FIG. 2 is a diagram showing the information stored in a storage of the computer used in the embodiment;

FIG. 3 is a flowchart showing a procedure for starting up the computer of the embodiment;

FIG. 4 is a diagram showing the memory state existing during the startup of the computer used in the embodiment;

FIG. 5 is a flowchart showing a procedure for processing after a failure has occurred in the first OS of the embodiment; and

FIG. 6 is a diagram showing the memory state changes existing after the failure has occurred in the first OS of the embodiment.

### DETAILED DESCRIPTION OF THE INVENTION

Preferred embodiments of the present invention are described below using the accompanying drawings.

### I. First Embodiment

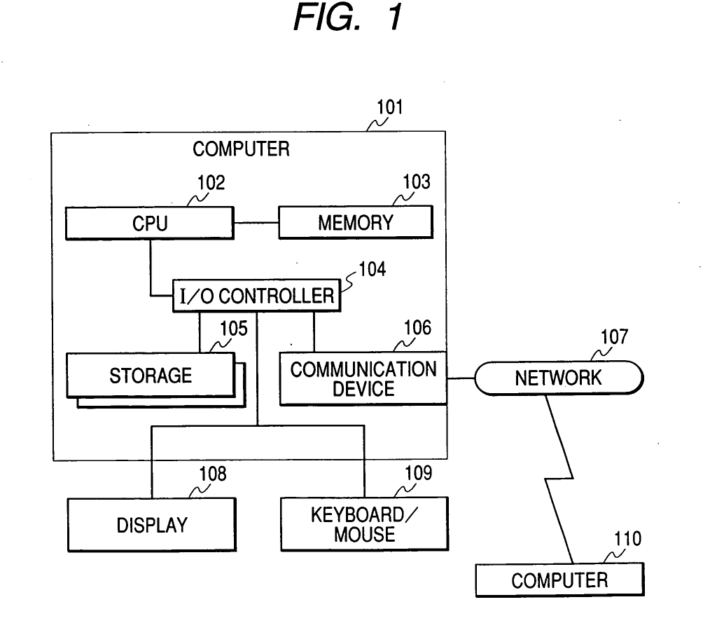

FIG. 1 shows a hardware configuration of a computer according to a first embodiment of the present invention. A computer 101 includes a CPU 102, a memory 103, an I/O controller 104, storage 105, and a communication device 106, and is connected to a display 108 and a keyboard/mouse 109. The computer 101 is further connected to a network 107 via the communication device 106, and can also communicate with a computer 110 disposed at a remote location. Quantitatively, the CPU 102, the storage 105, the communication device 106, and other elements in this configuration are not always singular each, and they can each be constructed of plural devices.

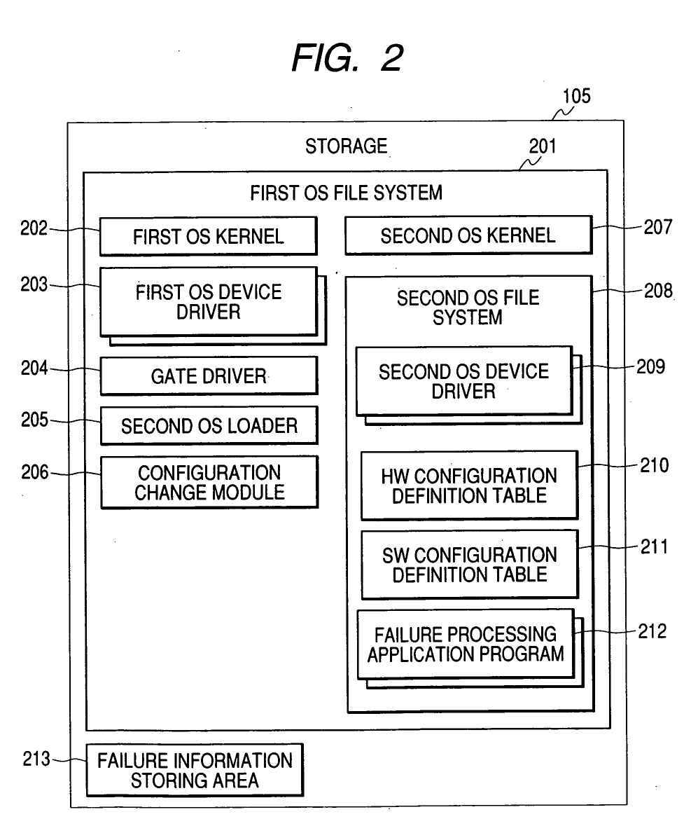

FIG. 2 shows the information stored into the storage 105 of the computer 101. The storage 105 has a first OS file system 201 and a failure information storing area 213. The first OS file system 201 includes a first OS kernel 202, first OS device drivers 203, a gate driver 204, a second OS loader 205, a configuration change module 206, a second OS kernel 207, a second OS file system 208, and other first OS information not concerned with the present invention. Furthermore, the second OS file system 208 includes second OS device drivers 209, a hardware (HW) configuration definition table 210, a software (SW) configuration definition table 211, and failure-processing application programs 212.

A first OS in this configuration is an OS whose failure information is to be stored according to the present invention, and only this first OS operates in a normal state of the computer A second OS is started up by the gate driver 204 in case of a failure in the first OS, and used for acquirement of first OS failure information and for failure analysis. Although the gate driver 204 is a module for starting up the second OS in case of a failure in the first OS, if the first OS has a user mode/kernel mode protection facility, the gate driver 204 can also be mounted as a first OS kernel extension facility that operates in a kernel mode. Alternatively, a facility equivalent to the gate driver can be incorporated in a kernel of the first OS.

The second OS loader 205 is an application program for the first OS, and this application program loads the second OS onto the memory before a failure occurs in the first OS. The configuration change module 206 is another application program for the first OS, and this application program notifies the second OS of any hardware configuration changes and administrator-issued, failure-processing method change instructions via the gate driver 204.

The failure information storing area 213 is an area for storing acquired failure information. When the second OS kernel 207 can perform read/write operations on the first OS file system 201, the failure information storing area 213 can be disposed in the first OS file system. It is also possible to adopt a configuration in which the second OS kernel 207 and/or the second OS file system 208 is to be disposed in an area (other than the first OS file system) that allows reading by the second OS loader 205.

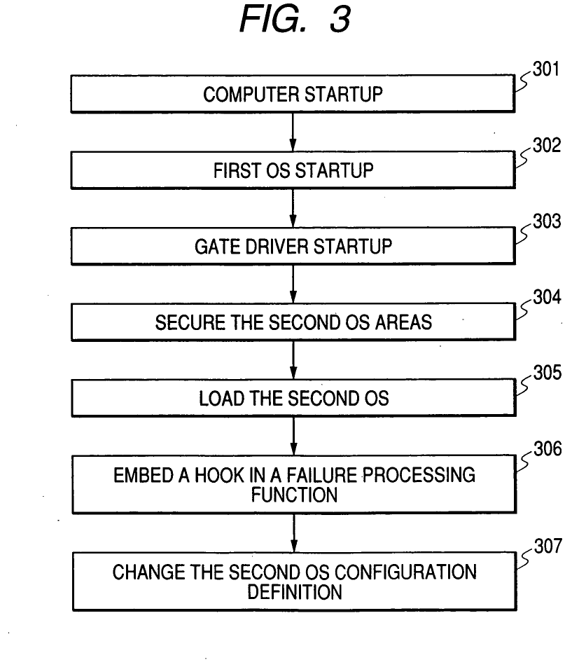

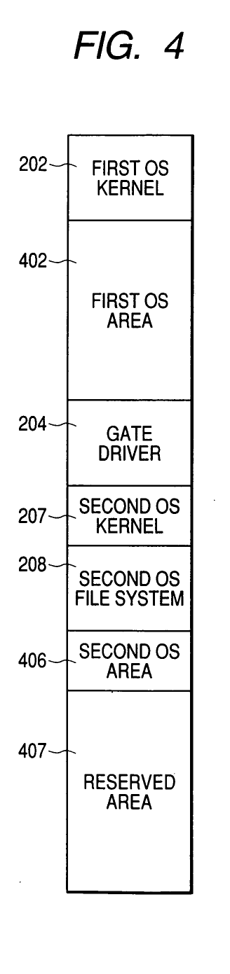

A procedure for starting up the computer 101 thus configured is shown in FIG. 3. The information disposed in the memory 103 of the computer 101 in accordance with the procedure is shown in FIG. 4. When the computer is started up in step 301, the first OS is first started up in step 302 by loading the first OS kernel 202 onto the memory 103 and creating a first OS area 402. In this procedure, the first OS acquires hardware configuration information, selects the device drivers required for I/O device control, from the first OS device drivers 203 present on the first OS file system 201, and loads the selected drivers into the first OS area 402.

After this, in step 303, the gate driver 204 is loaded as a kernel extension facility of the first OS onto the memory 103 and started up. In step 304, the started gate driver 204 secures the areas (area of the second OS kernel 207, area of the second OS file system 208, and second OS area) required for the second OS to operate with respect to the first OS, and the reserved area 407 required for the OS selection described later. The area of the second OS kernel 207 and the area of the second OS file system 208 must not be erased by the first OS being executed. Also, since these areas absolutely need to exist on the memory in the event of a failure, the areas must be secured as memory areas excluded from paging, even if the first OS supports demand paging. If the memory areas excluded from paging cannot be secured, the gate driver may not secure the required areas for operating the second OS, or the reserved area 407. Instead, it may be possible to use a method of limiting a memory area to be used for the first OS during the startup thereof and separating the area of the second OS kernel 207, the area of the second OS file system 208, a second OS area 406, and the reserved area 407, from the first OS beforehand. In this case, step 304 is omitted.

Next, in step 305, the second OS loader 205, an application program operating on the first OS, loads the second OS kernel 207 and the second OS file system 208, both stored in the storage 105, onto the memory 103. During this loading process, an entry point present on the second OS kernel 207 and the gate driver are linked to make preparations so that the second OS can be called at any time when necessary.

Next, in step 306, the gate driver 204 embeds a hook for detecting a failure in the first OS, in the first OS kernel 202. This focuses on the fact that if an unrecoverable failure occurs in a general OS, several predetermined functions (failure-processing functions) within the OS are called, and means that when these failure-processing functions are called by the occurrence of the failure, a string of instructions of the failure-processing functions are overlaid so that processing may be switched to the gate driver 204. When an internal function of the kernel is called, the OS may have a callback facility that executes another function set off by that call. When this callback facility is present, the gate driver 204 can also implement embedding a hook in the failure-processing functions by registering callback in each of the failure-processing functions. Furthermore, some specific OS's have a facility which, in case of an unrecoverable failure in a kernel, notifies the failure to an associated kernel module. The gate driver 204, when able to receive such a failure notice as a kernel module, can also use failure notification to the device drivers, instead of the hook embedded in each failure-processing function.

Finally, the configuration change module 206 is started up. In step 307, the configuration change module 206 incorporates the hardware configuration of the computer into the HW configuration definition table that has been unfolded on the second OS file system 208, and incorporates an initial value of a failure analysis method into the SW configuration definition table.

If the hardware configuration of the computer is changed during computer operation, the configuration change module 206 changes the HW configuration definition table 210 within the second OS file system 208. Also, a system administrator can perform changes on the failure-processing method, such as changing a dump acquisition destination device, by updating the SW configuration definition table 211 within the second OS file system 208 through the configuration change module 206.

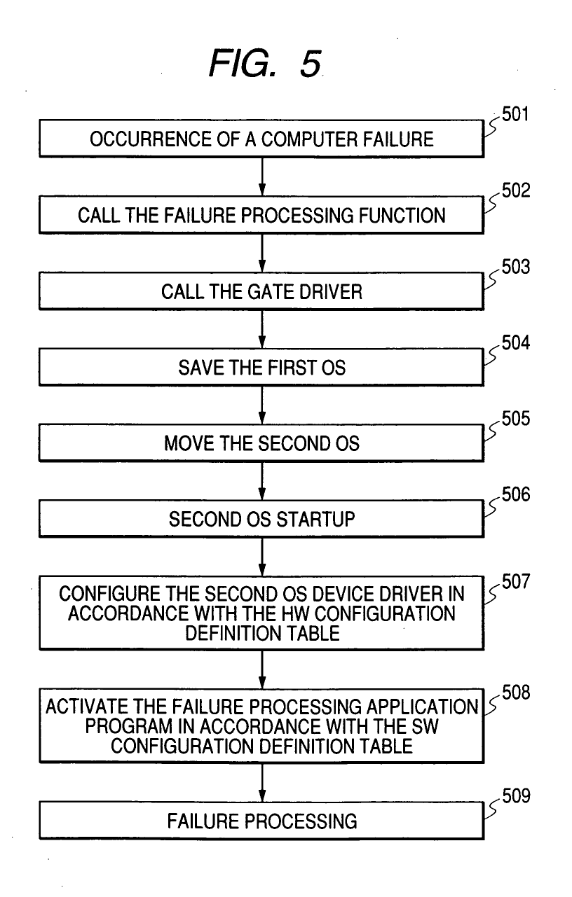

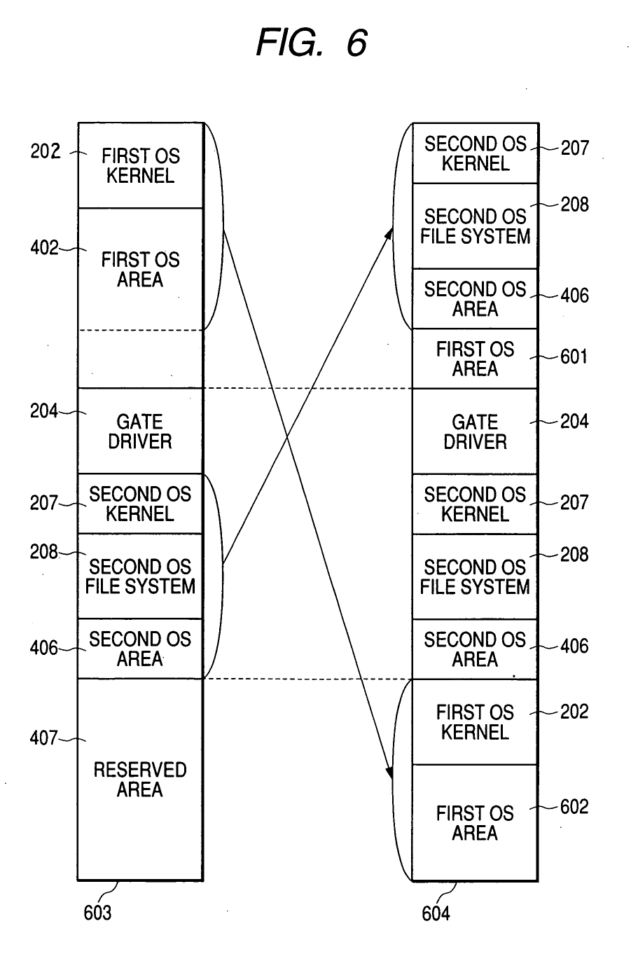

Next, a processing procedure to be used if the computer system fails is described below using a flowchart of FIG. 5 and memory maps of FIG. 6. A memory map 603 in FIG. 6 shows a state of the memory 103 existing before the gate driver 204 is called, and a memory map 604 shows a state of the memory 103 existing after the gate driver 204 has been called. If a computer system failure occurs in step 501, the failure-processing functions within the first OS are called in step 502. The gate driver 204 is then called in step 503 since the hook was embedded in each failure-processing function after the startup of the computer.

In step 504, as shown in FIG. 6, the gate driver 204 copies an area equal to a total size of the second OS kernel 207, second OS file system 208, and second OS area 406 to be copied, from the area of the first OS kernel 202 and the first OS area 402 into the reserved area 407. The memory maps in FIG. 6 show an example in which up to a little more than half of the first OS area has been copied into the reserved area 407. In step 505, the gate driver 204 copies the second OS kernel 207, the second OS file system 208, and the second OS area 406 into the area where the first OS kernel 202 and the first OS area 402 resided before they are saved in the reserved area 407. Steps 504 and 505 are performed assuming that the second OS is implemented in such a manner that it operates on a predetermined memory area with fixed physical addresses. If the second OS has a facility to start operating on an area with any physical addresses, steps 504 and 505 can be omitted and it is unnecessary to secure the reserved area 407.

When the copy of the second OS is completed, the gate driver 204 starts up the second OS kernel 207 in step 506. In step 507, the second OS kernel 207 makes reference to the HW configuration definition table 210 and constructs only the necessary second OS device drivers 209 among all constituent elements of the second OS file system 208.

The second OS device drivers 209 has already been loaded as part of the second OS file system 208 onto the memory 103 in step 305 and copied onto another area of the memory in step 505. At the time of completion of step 305, however, the device drivers required for failure processing has not been necessarily defined. In step 507, unnecessary device drivers are deleted for the second OS device drivers 209 on failure time in accordance with the current HW configuration definition table 210. Also, necessary and usable device drivers are copied from the first OS device drivers 203 into the area of the second OS device drivers 209 as required, and the second OS device drivers are thus reconfigured. This process makes it possible to save the memory space necessary for the second OS file system 208.

In step 508, the failure-processing procedure concerning the second OS kernel 207, determined by an instruction of the administrator, refers to the current SW configuration definition table 211 and activates the failure-processing application program 212.

In steps 507 and 508 that the second OS kernel 207 is to execute, only the second OS kernel 207, second OS file system 208, and second OS area 406 existing on the memory 103 are accessed and the storage 105 or other devices are not accessed. The second OS kernel 207 can therefore operate, even if the storage 105 or other devices are concerned with a failure in the first OS.

The failure-processing application program 212 performs a failure recovery process in accordance with the SW configuration definition table 211 in step 509. More specifically, the failure recovery process includes a first OS memory dump, failure notification to the administrator via the network, and remote debugging.

The first OS memory dump is a facility that outputs the first OS kernel 202 that was saved in step 504, and divided first OS areas 601, 602, to the failure information storing area 213 within the storage 105. If the hardware configuration permits, the memory dump can also be transmitted to the administrator-specified computer 110 via the communication device 106 and the network 107.

For failure notification to the administrator, the failure-processing application program 212 uses a communication facility of the second OS and notifies the occurrence of the failure to the computer 101 which is a terminal of the administrator, via the communication device 106 and the network 107.

For remote debugging, a remote login service is set in the SW configuration definition table 211 by the administrator. The administrator performs a remote login operation on the computer 101 from the computer 110 via the network 107. The second OS kernel 207 refers to the SW configuration definition table 211 and accepts the remote login operation. A kernel debugger that is called up after the remote login operation has been performed executes debugging while referring to the saved first OS kernel 202 and the first OS areas 601, 602, as in the memory map 604.

### II. Second Embodiment

The first embodiment assumes that the first OS kernel 202 and the second OS kernel 207 are OS's different from each other. In a second embodiment, however, the first OS kernel itself can also be used intact, instead of the second OS kernel. This can be achieved by extending a facility of the configuration change module 206 or of the second OS loader 205, then extracting the necessary device drivers from the first OS file system, and using these device drivers as the second OS device drivers 209. The first OS file system at this time is constructed of the thus-organized second OS device drivers 209, HW configuration definition table 210, SW configuration definition table 211, and failure-processing application program 212.

Compared with the failure-processing scheme that applies a VM, a scheme according to the first and second embodiments described above does not require the intervention of execution of such a program as a VM control program, and thus yields an advantageous effect that a CPU overhead does not occur. In addition, since the second OS can provide only necessary device drivers on the basis of actual hardware configuration definition information, there is the advantageous effect that the memory overhead involved is small.

Although examples in which the startup of the second OS is followed by failure processing have been shown in the description of the above embodiments, since the second OS can have facilities equivalent to those of the first OS, the present invention is also applicable to a case in which, as in a cluster configuration, the second OS is to take over processing of the first OS.

Additionally, although some specific OS's do not have a dump facility, the present invention can be used in such a manner that adding a dump facility to an OS not having a dump facility is achieved without modification or alteration of the OS.

1. A method for coping with OS failures, said method comprising:
starting up a first OS by loading the first OS onto a memory of a computer;
loading a second OS onto the memory by securing a second OS area not erased from the first OS;
starting up the second OS upon detection of a failure in the first OS; and
executing failure processing of the first OS under control of the second OS.

2. The method according to claim 1, further comprising, before the failure occurs in the first OS, embedding in the first OS a hook for detecting the failure.

3. The method according to claim 1, further comprising updating hardware configuration definition information of the second OS according to a hardware configuration of the computer existing before the failure occurs in the first OS.

4. The method according to claim 3, further comprising reconstructing necessary device drivers by use of the second OS so that after the startup of the second OS, the device drivers remain in an area of the second OS in accordance with the hardware configuration definition information thereof.

5. The method according to claim 1, further comprising, before the startup of the second OS, saving the first OS in a reserved area of the memory and moving the second OS to an original area of the first OS.

6. The method according to claim 1, wherein said step of executing failure processing uses the second OS to record in storage the failure-causing first OS present on the memory.

7. The method according to claim 1, wherein a kernel of the second OS is the same as that of the first OS.

8. The method according to claim 7, further comprising, before the failure occurs in the first OS, extracting necessary device drivers from internal device drivers of the first OS and using the thus-extracted device drivers as that of the second OS.

9. A program allowing a computer in which a first OS operates to execute:
a function which secures an area of a second OS not erased from the first OS, and loads the second OS onto a memory of the computer;
a function which starts up the second OS when a failure in the first OS is detected; and
a function which transfers control to a failure-processing application program executed under control of the second OS.

10. The program according to claim 9, further allowing the computer to execute a function which, before the failure occurs in the first OS, embedding in the first OS a hook for detecting the failure.

11. The program according to claim 9, further allowing the computer to execute a function which updates hardware configuration definition information of the second OS according to a hardware configuration of the computer existing before the failure occurs in the first OS.

12. The program according to claim 11, further allowing the computer to execute a function which reconstructs necessary device drivers by use of the second OS so that after the startup of the second OS, the device drivers remain in an area of the second OS in accordance with the hardware configuration definition information thereof.

13. The program according to claim 9, further allowing the computer to execute a function which, before the startup of the second OS, saves the first OS in a reserved area of the memory and moves the second OS to an original area of the first OS.

14. The program according to claim 9, wherein a kernel of the second OS is the same as that of the first OS.

15. The program according to claim 14, further allowing the computer to execute a function which, before the failure occurs in the first OS, extracts necessary device drivers from internal device drivers of the first OS and uses the thus-extracted device drivers as that of the second OS.
